(19) United States
(12) Patent Application Publication
(10) Pub. No.: US 2026/0360003 A1
(43) Pub. Date: Nov. 12, 2026

(54) POSTURE EVALUATION SYSTEM, POSTURE EVALUATION METHOD, AND NON-TRANSITORY COMPUTER READABLE MEDIUM

(71) Applicants: NEC Corporation, Tokyo (JP); INSTITUTE OF SCIENCE TOKYO, Tokyo (JP)

(72) Inventors: Shuhei NOYORI, Tokyo (JP); Yuki KOSAKA, Tokyo (JP); Akimoto NIMURA, Tokyo (JP); Koji FUJITA, Tokyo (JP); Takuya IBARA, Tokyo (JP)

(73) Assignees: NEC Corporation, Tokyo (JP); INSTITUTE OF SCIENCE TOKYO, Tokyo (JP)

(21) Appl. No.: 19/130,818

(22) PCT Filed: Nov. 10, 2023
(86) PCT No.: PCT/JP2023/040493

§ 371 Date: May 16, 2025

(30) Foreign Application Priority Data
Nov. 25, 2022 (JP) 2022-188606

(51) Int. Cl. G06T 7/73; G06T 5/50

(52) U.S. Cl. CPC G06T 7/73; G06T 5/50; G06T 2207/20044; G06T 2207/20221; G06T 2207/30196

(57) ABSTRACT

A posture evaluation system comprising a posture evaluation apparatus includes: a memory storing instructions; and one or more processors configured to execute the instructions to: estimate key point position information of key points including joints or anatomically characteristic points of a body of a subject and reliability of the key points from a photographed image obtained by photographing the body; generate a display image in which a key point having reliability lower than a predetermined threshold is superimposed on the photographed image in a display mode different from that of other key points having reliability equal to or higher than the predetermined threshold; correct the key point position information based on key point correction information, received from a user, for correcting the key point position information; and calculate feature values related to the joints or the anatomically characteristic points based on the corrected key point position information.

### TECHNICAL FIELD

The present disclosure relates to a posture evaluation apparatus, a posture evaluation system, a posture evaluation method, and a program.

### BACKGROUND ART

Recently, with the spread of online trainings and self-trainings, there is a growing demand that ordinary people having no specialized knowledge be able to evaluate their own postures. For example, there is a demand for a technology for evaluating the posture of a user based on an image obtained by photographing the user by a camera installed in a smartphone or the like.

Patent Literature 1 discloses a system for estimating the skeletal frame of a subject from an image obtained by photographing the subject, and classifying and retrieving the state of the posture, the behavior, or the like of the subject. In Patent Literature 1, the skeletal frame is estimated by extracting characteristic points such as joints as key points.

Key points can be extracted by using a machine-trained model such as a model trained through deep learning. However, although such a machine-trained model for an ordinary posture evaluation can extract key points relatively accurately in a posture such as a sitting posture or a standing posture, it may not accurately extract key points in a posture in a special state such as a posture during an exercise. When the extraction accuracy of key points is low, the accuracy of the posture evaluation also deteriorates. Therefore, a technology in which extracted key points are displayed over an image obtained by photographing a user in a superimposed manner, and the user corrects the key points on the display screen has been developed.

### CITATION LIST

### Patent Literature

Patent Literature 1: International Patent Publication No. 2021/250808

### SUMMARY OF INVENTION

### Technical Problem

However, when a user does not notice that key points are incorrectly extracted, they are not corrected and the accuracy of the posture evaluation may deteriorate.

An example object of the present disclosure is to provide a posture evaluation apparatus, a posture evaluation system, a posture evaluation method, and a program capable of accurately evaluating a posture.

### Solution to Problem

A posture evaluation apparatus according to the present disclosure includes: a skeletal-frame extraction unit configured to estimate key point position information of key points including joints or anatomically characteristic points of a body of a subject and reliability of the key points from a photographed image obtained by photographing the body; an image generation unit configured to generate a display image in which a key point having reliability lower than a predetermined threshold is superimposed on the photographed image in a display mode different from that of other key points having reliability equal to or higher than the predetermined threshold; a skeletal-frame correction unit configured to correct the key point position information based on key point correction information, received from a user, for correcting the key point position information; and a feature value calculation unit configured to calculate feature values related to the joints or the anatomically characteristic points based on the key point position information corrected by the skeletal-frame correction unit.

A posture evaluation system according to the present disclosure includes a posture evaluation apparatus and a subject terminal capable of communicating with the posture evaluation apparatus, in which the posture evaluation apparatus includes: a skeletal-frame extraction unit configured to estimate key point position information of key points including joints or anatomically characteristic points of a body of a subject and reliability of the key points from a photographed image the body of the subject acquired by the subject terminal; an image generation unit configured to generate a display image in which a key point having reliability lower than a predetermined threshold is superimposed on the photographed image in a display mode different from that of other key points having reliability equal to or higher than the predetermined threshold; a skeletal-frame correction unit configured to correct the key point position information based on key point correction information, received from a user, for correcting the key point position information; and a feature value calculation unit configured to calculate feature values related to the joints or the anatomically characteristic points based on the key point position information corrected by the skeletal-frame correction unit.

A posture evaluation method according to the present disclosure is a method, in which a posture evaluation apparatus: estimates key point position information of key points including joints or anatomically characteristic points of a body of a subject and reliability of the key points from a photographed image obtained by photographing the body; generates a display image in which a key point having reliability lower than a predetermined threshold is superimposed on the photographed image in a display mode different from that of other key points having reliability equal to or higher than the predetermined threshold; corrects the key point position information based on key point correction information, received from a user, for correcting the key point position information; and calculates feature values related to the joints or the anatomically characteristic points based on the key point position information corrected by the skeletal-frame correction unit.

A program according to the present disclosure causes a computer to perform: a process for estimating key point position information of key points including joints or anatomically characteristic points of a body of a subject and reliability of the key points from a photographed image obtained by photographing the body; a process for generating a display image in which a key point having reliability lower than a predetermined threshold is superimposed on the photographed image in a display mode different from that of other key points having reliability equal to or higher than the predetermined threshold; a process for correcting the key point position information based on key point correction information, received from a user, for correcting the key point position information; and a process for calculating feature values related to the joints or the anatomically characteristic points based on the key point position information corrected by the skeletal-frame correction unit.

### Advantageous Effects of Invention

It is possible to provide a posture evaluation apparatus, a posture evaluation system, a posture evaluation method, and a program capable of accurately evaluating a posture.

### BRIEF DESCRIPTION OF DRAWINGS

FIG. 1 is a block diagram showing a configuration of a posture evaluation apparatus according to the present disclosure;

FIG. 2 is a block diagram showing a configuration of a posture evaluation apparatus according to the present disclosure;

FIG. 3 shows an example of an image taken by a photographing unit according to the present disclosure;

FIG. 4 shows an example of a display image according to the present disclosure;

FIG. 5 shows an example of a display image according to the present disclosure in which key points are corrected;

FIG. 6 shows another example of a display image according to the present disclosure;

FIG. 7 is a flowchart showing a posture evaluation method according to the present disclosure;

FIG. 8 is a block diagram showing a configuration of a posture evaluation apparatus according to the present disclosure;

FIG. 9 shows an example of a display image according to the present disclosure;

FIG. 10 shows an example of a display image according to the present disclosure in which a spinal-column edge point group is corrected;

FIG. 11 is a flowchart showing a posture evaluation method according to the present disclosure;

FIG. 12 is a block diagram showing a configuration of a posture evaluation apparatus according to the present disclosure;

FIG. 13 shows an example of tensors and a display image thereof according to the present disclosure;

FIG. 14 is a block diagram showing a configuration of a posture evaluation system according to the present disclosure;

FIG. 15 is a block diagram showing a configuration of a subject terminal according to the present disclosure;

FIG. 16 shows an example of a display image according to the present disclosure; and

FIG. 17 is a block diagram showing an example of a configuration of a computer according to the present disclosure.

### EXAMPLE EMBODIMENT

### First Example Embodiment

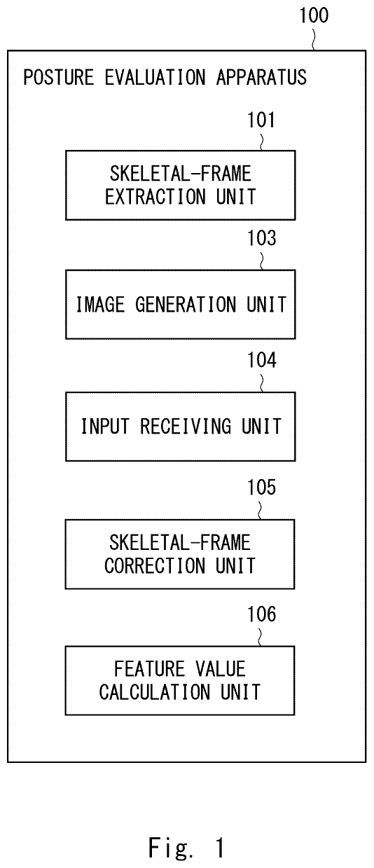

A first example embodiment according to the present invention will be described with reference to FIG. 1. FIG. 1 is a block diagram showing a configuration of a posture evaluation apparatus 100 according to the present disclosure.

The posture evaluation apparatus 100 according to the present disclosure is an apparatus for evaluating a posture of a subject based on a photographed image obtained by photographing the body of the subject by a camera such as a smartphone. Note that the subject means a person whose posture is evaluated by the posture evaluation apparatus 100. Specifically, the posture evaluation apparatus 100 estimates the skeletal frame or the like of the subject from the photographed image, and evaluates the posture of the subject based on the skeletal frame or the like. In this way, it is possible to evaluate the posture of the subject in a situation such as during an online training or a self-training.

As shown in FIG. 1, the posture evaluation apparatus 100 includes a skeletal-frame extraction unit 101, an image generation unit 103, an input receiving unit 104, a skeletal-frame correction unit 105, and a feature value calculation unit 106.

The skeletal-frame extraction unit 101 extracts, as key points, joints or anatomically characteristic points of the body of the subject from a photographed image obtained by photographing the body of the subject. In other words, the skeletal-frame extraction unit 101 estimates key point position information of key points and the reliability of the key points. That is, “extracting key points” means “estimating key point position information and reliability”. Therefore, it may also be expressed as “estimating key points” in this specification. Note that the anatomically characteristic points are, for example, wrists, elbows, shoulders, hips, knees, and ankles.

Note that the photographed image obtained by photographing the body of the subject is a two-dimensional image and may be a two-dimensional RGB image.

Further, the photographed image may be an image obtained by photographing the body of the subject from the side thereof. Further, the key point position information is position information of joints or anatomically characteristic points on the image.

Further, the position information of joints or anatomically characteristic points on the image is, for example, position information of pixels located at the centers of image areas corresponding to joints or anatomically characteristic points on the image.

Further, the position information of pixels is, for example, coordinates on the image. Note that the coordinates (e.g., coordinates of each joint or anatomically characteristic point) on the image are coordinates for indicating the position of a pixel on the two-dimensional image, for example, coordinates defined by using the center of the left-most and uppermost pixel on the two-dimensional image as the origin, and using the left/right direction or the horizontal direction as the x-direction and the up/down direction or the vertical direction as the y-direction. Further, the reliability (e.g., reliability of each joint or anatomically characteristic point) is a probability that a pixel specified in the key point position information estimated by the skeletal-frame extraction unit 101 is a joint or an anatomically characteristic point. For example, in the case where the skeletal-frame extraction unit 101 extracts a key point from a photographed image by using a machine-trained model, a score indicating that the key point is a joint or an anatomically characteristic point is calculated together with the key point position information. In this case, the reliability is the score. The higher the value of the score is, the higher the reliability is.

The image generation unit 103 generates a display image in which key points having reliability lower than a predetermined threshold are superimposed on the photographed image in a display mode different from that of the other key points having reliability equal to or higher than the predetermined threshold. In the display image, the key points are superimposed on the photographed image in such a manner that the user can move (drag) them on the photographed image. Note that the user refers to at least one of the subject whose posture is evaluated by the posture evaluation apparatus 100 and a person other than the subject who evaluates the posture of the subject by using the posture evaluation apparatus 100. Further, in the case where the subject evaluates his/her own posture by using the posture evaluation apparatus 100 in a self-training or the like, the subject is also the person who evaluates the posture of the subject. Further, in the case where the person who evaluates the posture of a subject evaluates the posture of a person other than himself/herself by using the posture evaluation apparatus 100, the person who evaluates the posture of a subject is, for example, a therapist or a trainer. Further, the display image may be displayed on a smartphone (subject terminal) owned by the user or on a display unit (not shown) provided in the posture evaluation apparatus 100.

Further, the different display mode means that the shape, color, and/or size indicating the key point is different, and/or the display format thereof (such as blinking) is different. Further, the different display mode also includes displaying a message indicating that the extraction of at least one of key points has failed on the display image.

The input receiving unit 104 receives key point correction information for correcting the key point position information from the user. Specifically, the input receiving unit 104 receives, as the key point correction information, position information of a key point(s) whose position has been corrected to the correct position(s) by the user by moving (dragging) the key point(s) on the display image. Note that the movement of a key point on the display image is not limited to the dragging thereof. For example, the user may select a key point he/she wants to correct, and then select a position to which the selected key point should be moved.

The skeletal-frame correction unit 105 corrects the key point position information based on the key point correction information.

The feature value calculation unit 106 calculates feature value related to the joints or anatomically characteristic points based on the key point position information corrected by the skeletal-frame correction unit 105.

According to the first example embodiment, it is possible to provide a posture evaluation apparatus 100 capable of accurately evaluating a posture. Specifically, the reliability is estimated together with the key point position information by the skeletal-frame extraction unit 101, and a key point(s) having low reliability is superimposed on the photographed image in a display mode different from that of the other key points by the image generation unit 103. Therefore, the user can distinguish a key point(s) which has low reliability and hence of which the possibility that the estimation is incorrect is high from the other key points. Therefore, it is possible to prevent the user from not noticing a key point(s) that has been incorrectly extracted and hence to prevent such a key point(s) from being not corrected. As a result, the accuracy of the posture evaluation can be increased. Therefore, it is possible to provide the posture evaluation apparatus 100 capable of accurately evaluating a posture.

Further, since feature values related to joints or anatomically characteristic points are calculated by the feature value calculation unit 106, the posture can be evaluated based on these feature values. Therefore, the posture can be evaluated with high accuracy equivalent to that of experts such as therapists and trainers.

### Second Example Embodiment

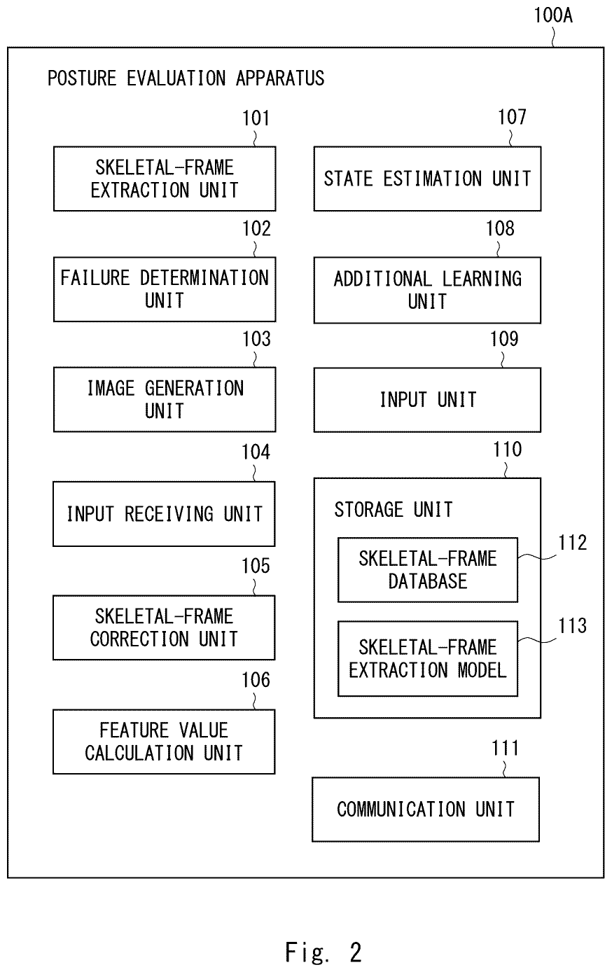

A second example embodiment according to the present invention will be described with reference to FIG. 2. FIG. 2 is a block diagram showing a configuration of a posture evaluation apparatus 100A according to the present disclosure. The posture evaluation apparatus 100A may be, for example, a server capable of communicating with a user terminal owned by a user, such as a smartphone, a tablet terminal, or a personal computer. Note that the posture evaluation apparatus 100A may be a user terminal (subject terminal) owned by a user, such as a smartphone, a tablet terminal, or a personal computer.

As shown in FIG. 2, the posture evaluation apparatus 100A according to the present disclosure includes a skeletal-frame extraction unit 101, a failure determination unit 102, an image generation unit 103, an input receiving unit 104, a skeletal-frame correction unit 105, a feature value calculation unit 106, a state estimation unit 107, an additional learning unit 108, an input unit 109, a storage unit 110, and a communication unit 111. The posture evaluation apparatus 100A may also include a display unit (not shown). The input unit 109 and the display unit (not shown) may be formed as one component, i.e., as a display equipped with a touch panel, or may be provided as separate components. Further, in the storage unit 110, a skeletal-frame database (referred to as a “skeletal-frame DB” in FIG. 2) 112, a skeletal-frame extraction model 113, and the like are stored.

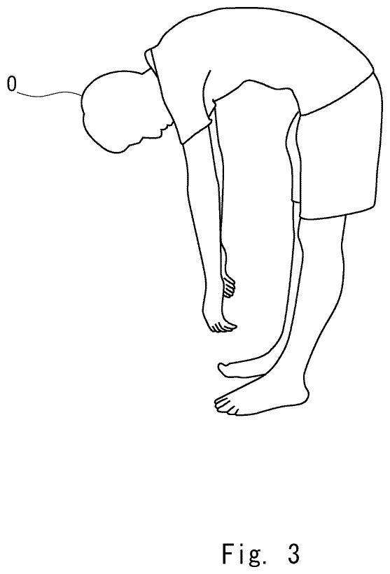

The skeletal-frame extraction unit 101 extracts, as key points, joints or anatomically characteristic points of the body of a subject from a photographed image obtained by photographing the body of the subject. In other words, the skeletal-frame extraction unit 101 estimates key point position information of key points and the reliability of the key points. For example, the skeletal-frame extraction unit 101 extracts a wrist, an elbow, a shoulder, a hip, a knee, and an ankle as key points P1 to P6, respectively, from the photographed image shown in FIG. 3, i.e., estimates key point position information of the key points P1 to P6 and the reliability thereof. Note that details of the position information and the reliability are the same as those described in the first example embodiment, and therefore descriptions thereof are omitted.

Specifically, the skeletal-frame extraction unit 101 estimates key point position information from the photographed image by using the already-trained skeletal-frame extraction model 113. Note that the posture evaluation apparatus 100A performs machine learning by using the skeletal-frame extraction model 113, which is a machine-trained model, and the skeletal-frame database 112, which is training data, and thereby generates the already-trained skeletal-frame extraction model 113 in advance.

Note that the key point position information may be information expressed by three-dimensional coordinates defined by a z-direction, which is the depth direction, in addition to the x-direction, which is the left/right direction or the horizontal direction, and the y-direction, which is the up/down direction or the vertical direction, of the two-dimensional image, which is the photographed image. Such three-dimensional information can be obtained by using a skeletal-frame extraction model 113 which estimates key point position information expressed by three-dimensional coordinates from the two-dimensional image.

Further, the parts of the body from which the skeletal-frame extraction unit 101 extracts key points may be, in addition to or instead of the above-described parts, other joints such as a cervical spine, a hip joint, and a knee joint, or other anatomically characteristic points such as a wrist, an elbow, a shoulder, a hip, a knee, and an ankle.

The failure determination unit 102 determines that the process performed in the skeletal-frame extraction unit 101 has failed when the number of key points having reliability lower than the predetermined threshold is equal to or larger than a predetermined criterion. The predetermined criterion is, for example, the upper limit of the number of key points having reliability lower than the predetermined threshold. Alternatively, the predetermined criterion may be, for example, the ratio of the number of key points having reliability lower than the predetermined threshold to the total number of key points.

The image generation unit 103 generates a display image in which key points having reliability lower than the predetermined threshold are superimposed on the photographed image in a display mode different from that of the other key points having reliability equal to or higher than the predetermined threshold. In the display image, the key points are superimposed on the photographed image in such a manner that the user can move (drag) them on the photographed image.

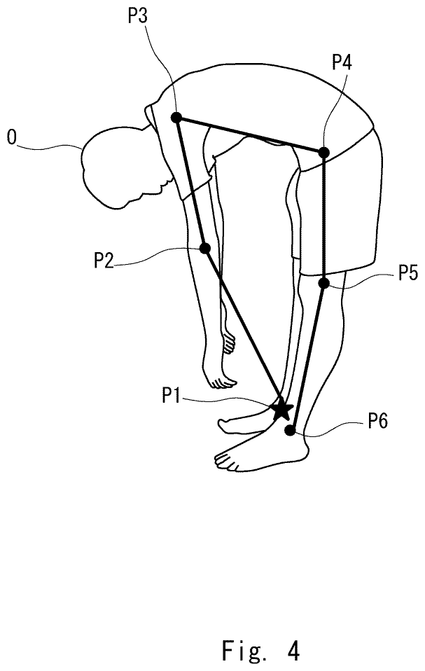

FIG. 4 shows an example of a display image generated by the image generation unit 103. In the example shown in FIG. 4, the reliability of a key point P1 on a wrist is lower than the predetermined threshold and hence is superimposed on the photographed image in a shape and a size different from those of the other key points P2 to P6. In this way, it becomes quite obvious that the extraction of the key point P1 of the wrist is incorrect.

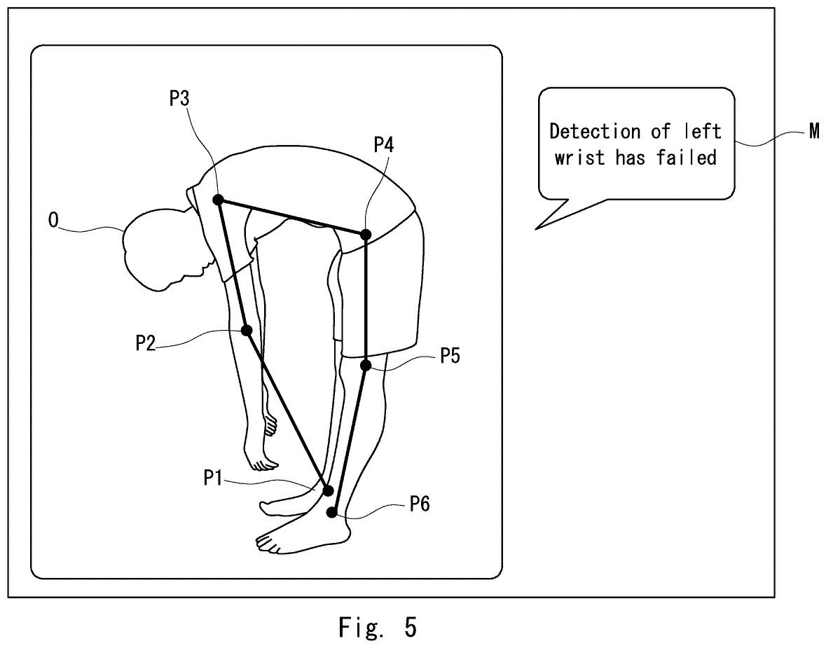

Further, FIG. 5 shows another example of a display image generated by the image generation unit 103. In the example shown in FIG. 5, a message M “Detection of left wrist has failed” is displayed in the display image. In this way, it becomes quite obvious that the extraction of the key point P1 of the left wrist is incorrect.

Note that the predetermined threshold is a value determined based on the importance of the key point in the estimation by the state estimation unit 107 (which will be described later).

The predetermined threshold will be described in a more detailed manner. Firstly, importanceₖ, which represents the importance of a key point k in the estimation by the state estimation unit 107, is defined by the below-shown Expression (1).

$$\begin{matrix}[ Expression 1 ] & \\ {importance}_{k} = {\sum }_{i = 1}^{n} {\sum }_{j = 1}^{m} {a}_{ij} {b}_{jk} ( k = 1 , … , l ) & ( 1 )\end{matrix}$$

In the expression: n is the number of parts to be evaluated; m is the number of features values; and 1 is the number of key points. Further, aᵢⱼ is the importance of a feature value j (j=1, . . . , m) in a state estimation model fᵢ for evaluating a part i to be evaluated (i=1, . . . , n), and aᵢⱼ is equal to or higher than 0 (aᵢⱼ>0). Further, when the feature value j is not used for the evaluation of the part i, aᵢⱼ is equal to 0 (aᵢⱼ=0). In the case where linear regression is used as the state estimation model by using Permutation importance or a Gini function, the absolute value of a coefficient corresponding to each feature value may be used as aᵢⱼ. Further, bⱼₖ is 1 when the key point k is used for the calculation of the feature value j and is 0 when the key point k is not used therefor. Further, the importance importanceₖ of the key point k may be a monotonically increasing function (importanceₖ>0) for the importance of the feature value calculated by using the key point k.

When the importance importanceₖ of the key point is defined as described above, the predetermined threshold threshₖ is defined by the below-shown Expression (2).

$$\begin{matrix}[ Expression 2 ] & \\ {thresh}_{k} = \frac{1}{1 + exp ( - {α}_{k} ( {importance}_{k} + {β}_{k} ) )} & ( 2 )\end{matrix}$$

In the expression, αₖ and βₖ are constants empirically determined from the photographed image and the extraction accuracy of the machine-trained model (skeletal-frame extraction model 113) used in the skeletal-frame extraction unit 101, and aₖ is higher than 0 (aₖ>0). Further, α₁=α₂=α₁, and β₁=B₂= . . . =β₁; and αₖ and βₖ may be different values for each key point.

Further, the predetermined threshold threshₖ may be an improper monotone increasing function (range [0, 1]) of the importance importanceₖ.

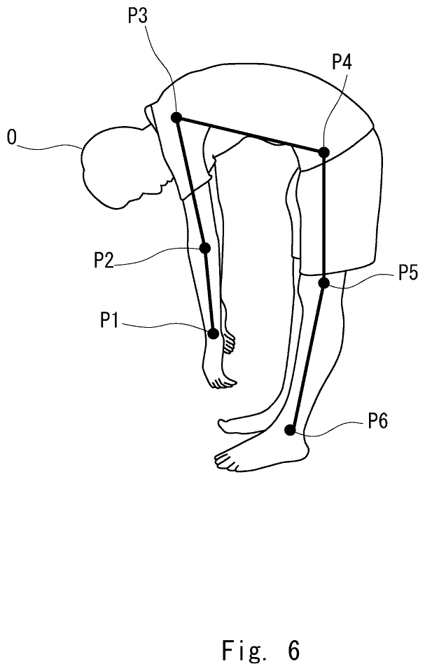

The input receiving unit 104 receives key point correction information for correcting the key point position information from the user. Specifically, the input receiving unit 104 receives, as the key point correction information, position information of a key point(s) whose position(s) has been corrected to the correct position(s) by the user by dragging the key point(s) on the display image. FIG. 6 shows a display image showing the key point P1 which has been corrected by the user. The input receiving unit 104 receives, as the key point correction information, position information of the corrected key point P1 shown in FIG. 6.

The skeletal-frame correction unit 105 corrects the key point position information based on the key point correction information.

The feature value calculation unit 106 calculates feature values related to joints or anatomically characteristic points based on the key point position information corrected by the skeletal-frame correction unit 105. Specifically, the feature value calculation unit 106 calculates, as a feature value, an angle formed by two straight lines (also called “bones”) each of which connects two or more of the key points P1 to P6, or an angle formed by such a straight line and a vertical straight line or a horizontal straight line on the image.

The state estimation unit 107 estimates the state of the posture of a subject O based on the feature values calculated by the feature value calculation unit 106. Specifically, for example, the state estimation unit 107 estimates the state of the posture of the subject O based on the feature values and a reference value list (not shown) stored in the storage unit 110. The reference value list is, for example, data in which types of postures are associated with reference values for feature values in these postures.

The additional learning unit 108 performs additional learning for the skeletal-frame extraction model 113 by using the photographed image and the key point position information corrected by the skeletal-frame correction unit 105. In this way, the accuracy of the extraction of key points using the skeletal-frame extraction model 113 can be further improved.

The input unit 109 may receive an operation instruction from the user. The input unit 109 may be formed by a keyboard or may be formed by a touch panel-type display device. The input unit 109 may be formed by a keyboard or a touch panel connected to the posture evaluation apparatus 100A itself.

In the storage unit 110, the skeletal-frame database 112, the skeletal-frame extraction model 113, and the like are stored. Further, the storage unit 110 may include a nonvolatile memory (e.g., ROM (Read Only Memory)) in which various programs and various data necessary for processing are permanently stored. Further, an HDD or an SSD may be used for the storage unit 110. Further, the storage unit 110 may include a volatile memory (e.g., RAM (Random Access Memory) used as a work area. The aforementioned program may be loaded from a portable recording medium such as an optical disk or a semiconductor memory, or downloaded from a server apparatus on a network.

The skeletal-frame database 112 is a database in which for each of a plurality of images obtained by photographing bodies, the image is associated with key point position information which is used as a correct answer label.

The skeletal-frame extraction model 113 is a machine-trained model for estimating key point position information from a photographed image obtained by photographing a body. In other words, the skeletal-frame extraction model 113 is a machine-trained model for estimating key point position information by using a photographed image obtained by photographing a body as an input. Note that in this specification, the machine learning may be deep learning, but it is not limited to any particular learning.

The communication unit 111 communicates with a subject terminal (not shown). Further, the communication unit 111 may also communicate with an external server or other terminal apparatuses or the like. The communication unit 111 may include an antenna (not shown) for performing radio communication or an interface such as a NIC (Network Interface Card) for performing wired communication.

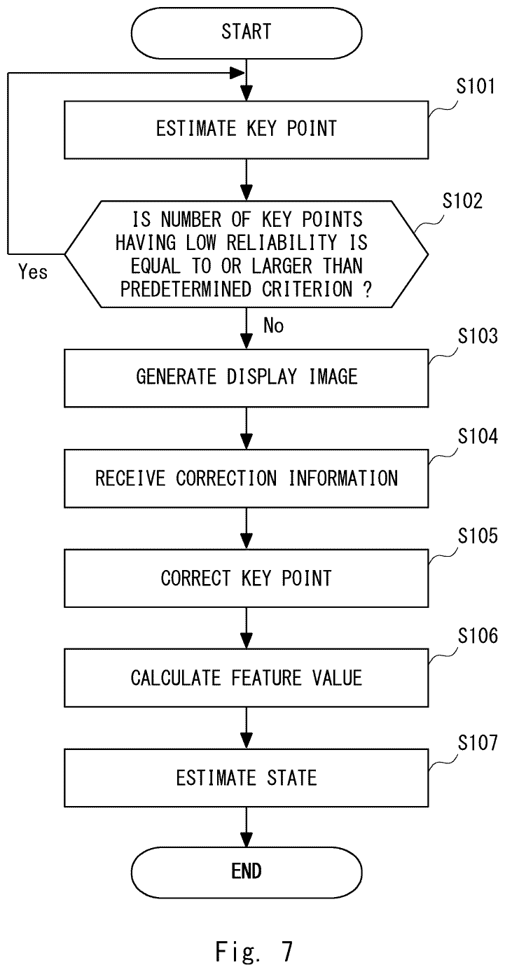

Next, a posture evaluation method according to the present disclosure will be described with reference to FIG. 7.

Firstly, the skeletal-frame extraction unit 101 estimates key points from a photographed image obtained by photographing the body of a subject O (Step S101). Specifically, the skeletal-frame extraction unit 101 estimates key point position information of key points including joints or anatomically characteristic points of the body and the reliability of the key points from the photographed image.

Next, the failure determination unit 102 determines whether the number of key points having reliability lower than a predetermined threshold is equal to or larger than a predetermined criterion (Step S102). In the step S102, when the number of key points having reliability lower than the predetermined threshold is equal to or higher than the predetermined criterion (Step S102; Yes), the failure determination unit 102 determines that the process performed in the skeletal-frame extraction unit 101 has failed and returns to the process in the step S101. As a result, a photographed image is newly acquired, and key points are extracted again based on the new photographed image. On the other hand, in the step S102, when the number of key points having reliability lower than the predetermined threshold is smaller than the predetermined criterion (Step S102; No), the failure determination unit 102 determines that the process performed in the skeletal-frame extraction unit 101 has succeeded and proceeds to a process in a step S103.

Next, the image generation unit 103 generates a display image in which the key points having reliability lower than the predetermined threshold are superimposed on the photographed image in a display mode different from that of the other key points having reliability equal to or higher than the predetermined threshold (Step S103).

Next, the input receiving unit 104 receives key point correction information for correcting the key point position information from the user (Step S104).

Next, the skeletal-frame correction unit 105 corrects the key point position information based on the key point correction information (Step S105).

Next, the feature value calculation unit 106 calculates feature values related to joints or anatomically characteristic points based on the key point position information which has been corrected in the step S105 (Step S106).

Next, the state estimation unit 107 estimates the state of the posture of the subject O based on the feature values calculated in the step S106 (Step S107).

According to the second example embodiment, it is possible to provide the posture evaluation apparatus 100A capable of accurately evaluating a posture. Specifically, reliability is estimated together with key point position information by the skeletal-frame extraction unit 101, and key points having low reliability are superimposed on the photographed image in a display mode different from that of the other key points by the image generation unit 103. Therefore, the user can distinguish a key point(s) which has low reliability and hence of which the possibility that the estimation is incorrect is high from the other key points. Therefore, it is possible to prevent the user from not noticing a key point(s) that has been incorrectly extracted and hence to prevent such a key point(s) from being not corrected. As a result, the accuracy of the posture evaluation can be increased. Therefore, it is possible to provide the posture evaluation apparatus 100A capable of accurately evaluating a posture.

Further, since feature values related to joints or anatomically characteristic points are calculated by the feature value calculation unit 106, the posture can be evaluated based on these feature values. Therefore, the posture can be evaluated with high accuracy equivalent to that of experts such as therapists and trainers.

Further, the predetermined threshold is determined based on the importance of key points in the estimation by the state estimation unit 107, so that it is possible to prevent the user from spending unnecessary time which would otherwise be caused as the user corrects the positions of key points which are not so important in the evaluation of the posture.

Further, the additional learning unit 108 performs additional learning for the skeletal-frame extraction model 113 by using the photographed image and the corrected key point position information, so that the accuracy of the extraction of key points using the skeletal-frame extraction model 113 can be further improved.

Further, when the number of key points having reliability lower than the predetermined threshold is equal to or greater than the predetermined criterion, the failure determination unit 102 determines that the process performed in the skeletal-frame extraction unit 101 has failed. As a result, a photographed image is newly acquired, and key points are extracted again based on the new photographed image. Consequently, it is possible to prevent such a situation that the user has to correct a large number of key points.

### Third Example Embodiment

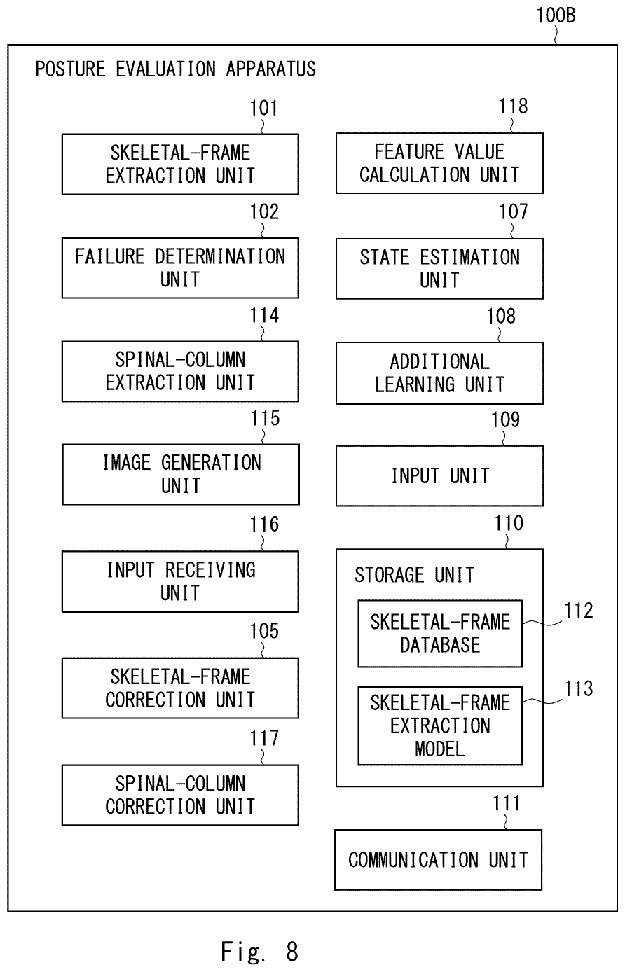

A third example embodiment according to the present invention will be described with reference to FIG. 8. FIG. 8 is a block diagram showing a configuration of a posture evaluation apparatus 100B according to the present disclosure. As shown in FIG. 8, the posture evaluation apparatus 100B according to the present disclosure differs from the posture evaluation apparatus 100A according to the present disclosure in that it additionally includes a spinal-column extraction unit 114 and a spinal-column correction unit 117, and that the processes performed in an image generation unit 115, an input receiving unit 116, and a feature value calculation unit 118 are different from those performed in the posture evaluation apparatus 100A according to the present disclosure. Therefore, the same reference numerals (or symbols) are assigned to the components/structures in the configuration of the posture evaluation apparatus 100B according to the present disclosure which are the same as those in the configuration of the posture evaluation apparatus 100A according to the present disclosure, and descriptions thereof are omitted.

The spinal-column extraction unit 114 estimates spinal-column edge position information of a spinal-column edge point group consisting of a predetermined number of points representing the shape of the spinal column of the body on the photographed image based on position information (coordinates on the image) of at least the cervical spine, the hip joint, and the knee joint of the body on the photographed image. For example, the spinal-column extraction unit 114 may trim the photographed image to obtain an area around the trunk based on position information (coordinates on the image) of the cervical spine, the hip joint, and the knee joint, and then acquire spinal-column edge position information of the spinal-column edge point group by performing an edge extraction process in the obtained area. Details of the process performed in the spinal-column extraction unit 114 are, for example, the same as those described in Japanese Patent Application No. 2022-058198, and therefore descriptions thereof are omitted. Further, the spinal-column extraction unit 114 may extract a silhouette of the subject from the photographed image by using a machine-trained model such as a model trained through deep learning, and specify a spinal-column area from the edges of the extracted silhouette of the subject based on position information (coordinates on the image) of the cervical spine, the hip joint, and the knee joint.

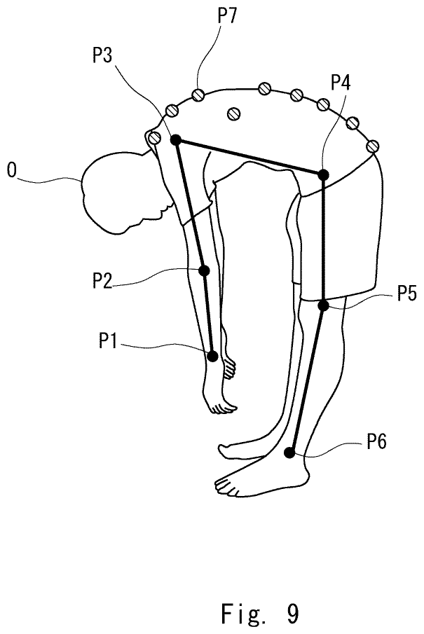

The image generation unit 115 generates a display image by superimposing key points having reliability lower than the predetermined threshold on the photographed image in a display mode different from that of the other key points having reliability equal to or higher than the predetermined threshold, and also superimposing the spinal-column edge point group on the photographed image. Further, the image generation unit 115 superimposes the key points and the spinal-column edge point group on the photographed image in such a manner that the user can move (drag) them on the photographed image. FIG. 9 shows an example of a display image generated by the image generation unit 115. In the example shown in FIG. 9, the reliability of all the key points P1 to P6 is equal to or higher than the predetermined threshold, so that they are all superimposed on the photographed image in the same display mode. Further, in the example shown in FIG. 9, spinal-column edge point group P7, . . . are superimposed on the photographed image. Note that in the spinal-column edge point group P1, . . . , the estimation of the fourth point P7 as counted from the neck side of the subject O toward the hip side thereof is incorrect. Therefore, the user can move this fourth point P7 to the correct position.

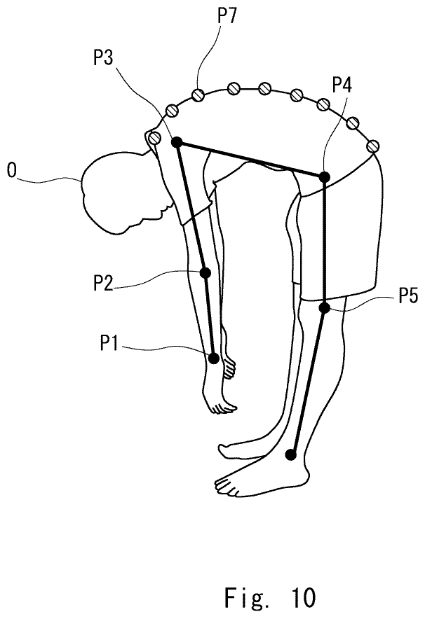

Next, similarly to the second example embodiment, the input receiving unit 116 receives key point correction information for correcting the key point position information from the user. Further, the input receiving unit 116 also receives spinal-column edge correction information for correcting the spinal-column edge position information from the user. Specifically, the input receiving unit 116 receives, as the spinal-column edge correction information, position information of the spinal-column edge point group P1, . . . , which has been corrected by having the user correct the point in the original spinal-column edge point group P1, . . . to the correct position by dragging the point on the display image. FIG. 10 shows a display image showing the spinal-column edge point group P1, . . . which has been corrected by the user. The input receiving unit 116 receives position information of the corrected spinal-column edge point group P1, . . . shown in FIG. 10 as the spinal-column edge correction information.

The spinal-column correction unit 117 corrects the spinal-column edge position information based on the spinal-column edge correction information.

Similarly to the second example embodiment, the feature value calculation unit 118 calculates feature values based on the key point position information corrected by the skeletal-frame correction unit 105.

Further, the feature value calculation unit 118 calculates feature values based on the spinal-column edge position information corrected by the spinal-column correction unit 117. Specifically, the feature value calculation unit 118 calculates feature values related to the spinal column based on the position information (coordinates on the image) of the cervical spine, the hip joint, and the knee joint estimated by the spinal-column extraction unit 114 and the spinal-column edge position information corrected by the spinal-column correction unit 117. Details of the process for calculating feature values related to the spinal column performed in the feature value calculation unit 118 are, for example, the same as those described in Japanese Patent Application No. 2022-058198, and therefore descriptions thereof are omitted.

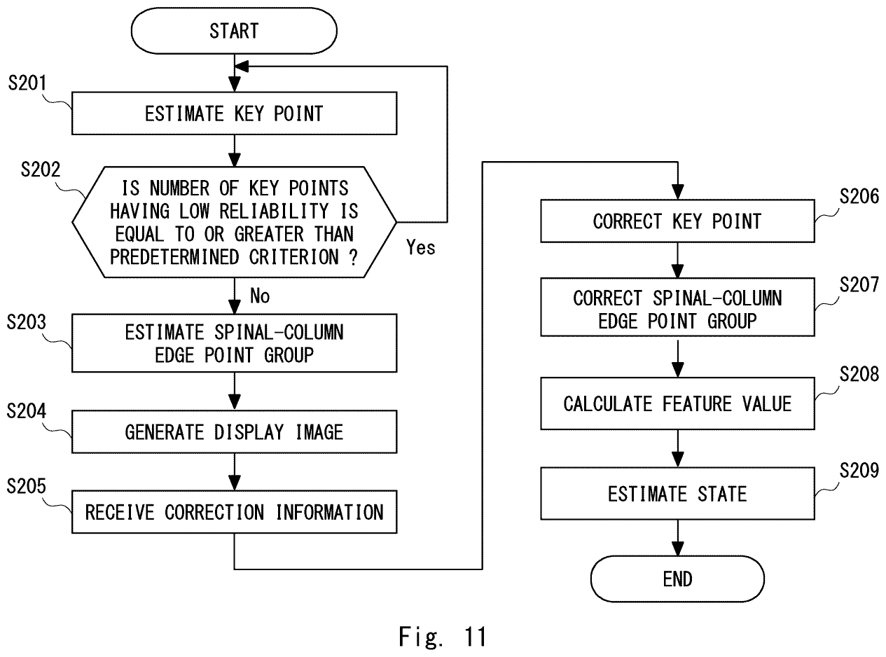

Next, a posture evaluation method according to the present disclosure will be described with reference to FIG. 11. Since processes in steps S201, S202, S206 and S209 shown in FIG. 11 are the same as those in the steps S101, S102, S105 and S107 shown in FIG. 7, descriptions thereof will be omitted.

The spinal-column extraction unit 114 extracts a spinal-column edge point group from a photographed image obtained by photographing the body of a subject O, i.e., estimates spinal-column edge position information (Step S203).

Next, the image generation unit 115 generates a display image by superimposing key points having reliability lower than the predetermined threshold on the photographed image in a display mode different from that of the other key points having reliability equal to or higher than the predetermined threshold, and also superimposing the spinal-column edge point group on the photographed image (Step S204).

Next, the input receiving unit 116 receives key point correction information for correcting the key point position information from the user, and also receives spinal-column edge correction information for correcting the spinal-column edge position information from the user (Step S205).

Further, after the step S206, the spinal-column correction unit 117 corrects the spinal-column edge position information based on the spinal-column edge correction information (Step S207).

Next, the feature value calculation unit 118 calculates feature values related to the joints or anatomically characteristic points based on the key point position information corrected in the step S105, and calculates feature values related to the spinal column based on the spinal-column edge position information corrected in the step S207 (Step S208).

According to the third example embodiment, since the posture can be evaluated based on the shape of the spinal column on the image, the posture can be accurately evaluated. Further, in general, expensive specialized equipment is required to estimate the shape of a spinal column. However, according to the third example embodiment, it is possible to evaluate a posture based on the shape of a spinal column without using such expensive specialized equipment, and thereby to evaluate the posture at a relatively low cost.

### Fourth Example Embodiment

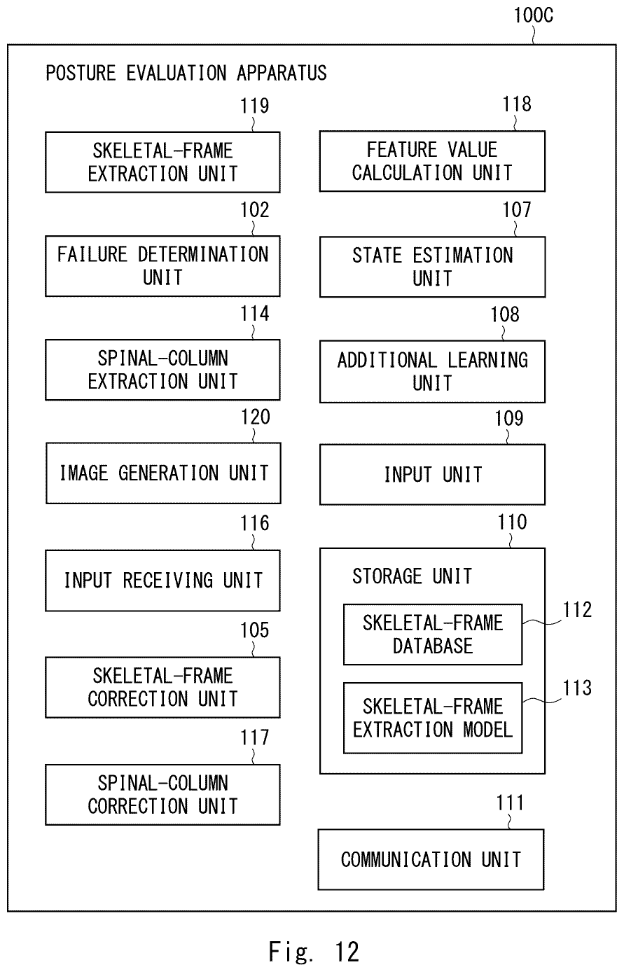

A fourth example embodiment according to the present invention will be described with reference to FIG. 12. FIG. 12 is a block diagram showing a configuration of a posture evaluation apparatus 100C according to the present disclosure. As shown in FIG. 12, the processes performed in a skeletal-frame extraction unit 119 and an image generation unit 120 of the posture evaluation apparatus 100C according to the present disclosure are different from those performed in the posture evaluation apparatus 100A or 100B according to the present disclosure. Therefore, the same reference numerals (or symbols) are assigned to the components/structures in the configuration of the posture evaluation apparatus 100C according to the present disclosure which are the same as those in the configuration of the posture evaluation apparatus 100A or 100B according to the present disclosure, and descriptions thereof are omitted. Note that in FIG. 12 and the following description, differences between the posture evaluation apparatus 100C according to the present disclosure and the posture evaluation apparatus 100B according to the present disclosure are mainly described.

Similarly to the third example embodiment, the skeletal-frame extraction unit 119 extracts, as key points, joints or anatomically characteristic points of the body of the subject O from a photographed image obtained by photographing the body of the subject O, i.e., estimates key point position information of key points and the reliability of the key points.

Further, the skeletal-frame extraction unit 119 also estimates a probability that a pixel included in the photographed image is a joint or an anatomically characteristic point. For example, in the case where the skeletal-frame extraction unit 101 extracts key points from a photographed image by using a machine-trained model, a score indicating that a pixel included in the photographed image is a joint or an anatomically characteristic point is calculated. In this case, the score corresponds to the probability. The higher the value of the score is, the higher the reliability is. Note that the probability of some or all of the pixels included in a photographed image estimated by the skeletal-frame extraction unit 119 may be expressed in the form of a matrix.

Similarly to the third example embodiment, the image generation unit 120 generates a display image by superimposing key points having reliability lower than the predetermined threshold on the photographed image in a display mode different from that of the other key points having reliability equal to or higher than the predetermined threshold, and also superimposing the spinal-column edge point group on the photographed image.

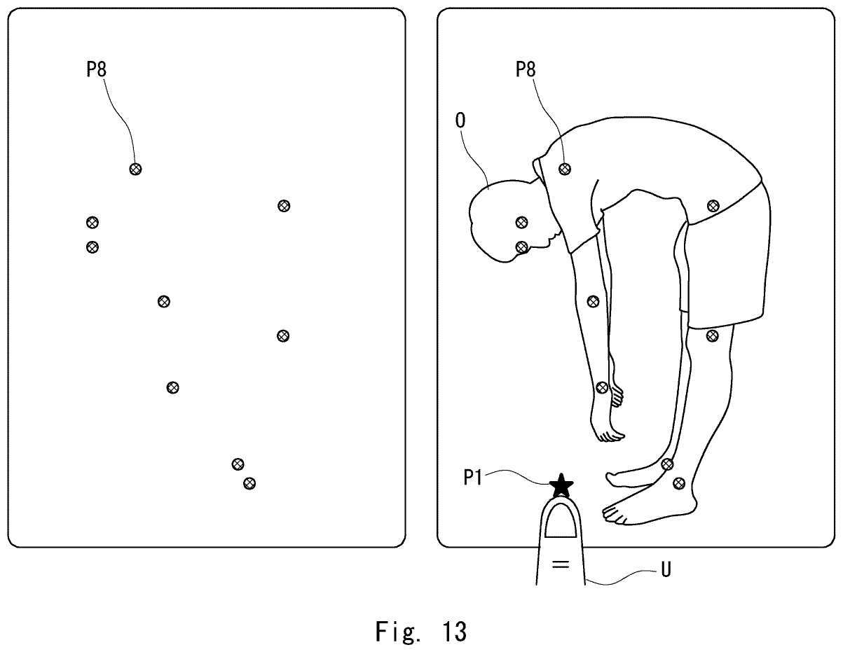

Further, the image generation unit 120 also generates a tensor for displaying the probability by displaying pixels by pixel values corresponding to the above-described probability, and generates a display image by also superimposing the generated tensor on the photographed image. The tensor generated by the image generation unit 120 is shown on the left side of FIG. 13. As shown in FIG. 13, in this tensor, the pixel value of a pixel part P8 of which the above-described probability is high (i.e., the score value is large) is displayed with a pixel value larger than those of the other pixel parts. Further, the display image in which the tensor is superimposed on the photographed image is shown on the right side of FIG. 13. This display image shown on the right side of FIG. 13 is a display image that is displayed when the user U is dragging the key point P1 of the wrist in order to correct the position of the key point P1 to the correct position. As shown on the right side of FIG. 13, the image generation unit 120 generates a display image in which the tensor is also superimposed on the photographed image as the display image that is displayed when the user U corrects the key point P1. In this way, a candidate position P8 for the correct position of the key point P1 is displayed on this display image, so that the user U can correct the key point P1 more easily.

According to the fourth example embodiment, a probability that a pixel included in a photographed image is a joint or an anatomically characteristic point is calculated by the skeletal-frame extraction unit 119, and a tensor for displaying a probability by displaying pixels by pixel values corresponding to the above-described probability is also generated by the image generation unit 120. Then, a display image in which the tensor is also superimposed on the photographed image is generated as a display image that is displayed when the user corrects a key point by the image generation unit 120. Therefore, a candidate position for the correct position of the key point is displayed on this display image, so that the user U can correct the key point more easily.

### Fifth Example Embodiment

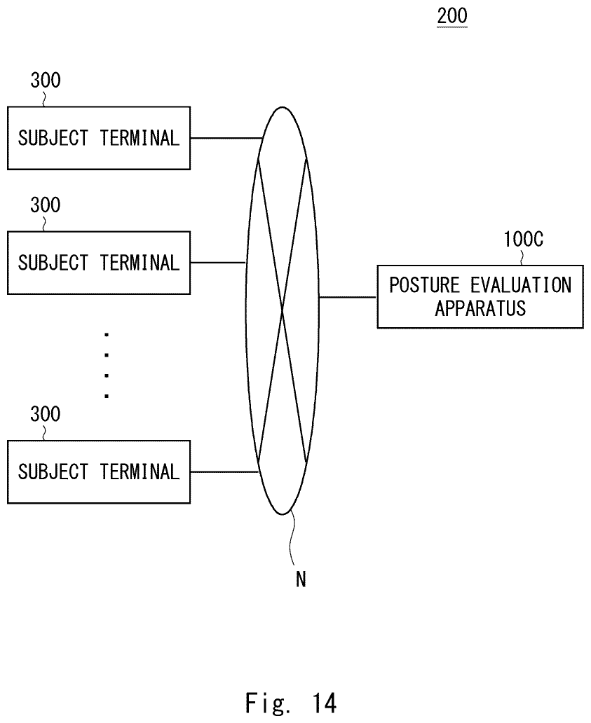

A posture evaluation system 200 according to the present disclosure of the present invention will be described with reference to FIG. 14. FIG. 14 shows a configuration of the posture evaluation system 200 according to the present disclosure. As shown in FIG. 14, the posture evaluation system 200 includes a posture evaluation apparatus 100C and a subject terminal 300 capable of communicating with the posture evaluation apparatus 100C. The posture evaluation apparatus 100C and the subject terminal 300 can communicate with each other through a network N. Further, as shown in FIG. 14, one or more subject terminals 300, . . . may be able to communicate with the posture evaluation apparatus 100C.

Further, the subject terminal 300 may be a smartphone, a tablet terminal, a personal computer, or the like owned by the subject.

The posture evaluation apparatus 100C according to the present disclosure acquires a photographed image obtained by photographing the body of a subject from the subject terminal 300.

Further, a display image created by the image generation unit 120 of the posture evaluation apparatus 100C is transmitted to the subject terminal 300 and displayed on a display unit 302 (described later) of the subject terminal 300.

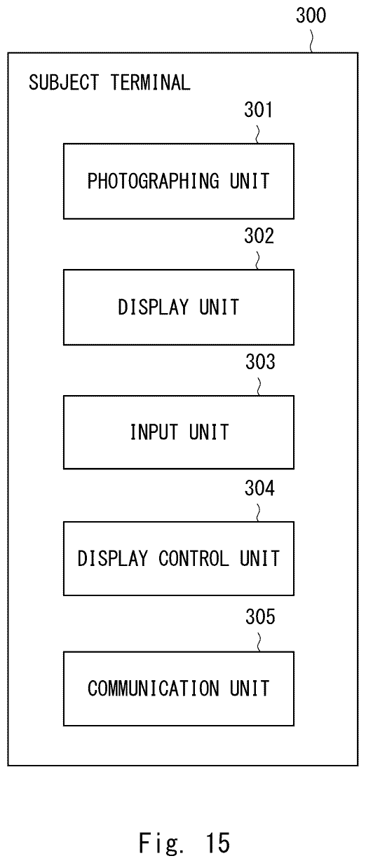

FIG. 15 shows an example of a configuration of the subject terminal 300. As shown in FIG. 15, the subject terminal 300 includes a photographing unit 301, a display unit 302, an input unit 303, a display control unit 304, and a communication unit 305.

The photographing unit 301 photographs the body of a subject and thereby acquires a photographed image thereof. The image taken by the photographing unit 301 is a two-dimensional image and may be a two-dimensional RGB image. The subject terminal 300 transmits this photographed image to the posture evaluation apparatus 100C.

Further, the photographing unit 301 may also acquire a moving image of the body of the subject by photographing, i.e., filming, the body of the subject. In this case, the user may specify a time point at which the posture is evaluated by operating the input unit 109 of the posture evaluation apparatus 100C. Alternatively, the subject may specify a time point at which the posture is evaluated by operating the input unit 303 of the subject terminal 300. Then, the image at the time point specified by the user or the subject may be input to the skeletal-frame extraction unit 119 and the spinal-column extraction unit 114.

The display unit 302 displays a display image received from the posture evaluation apparatus 100C. The display unit 302 is formed by any of various types of display means such as an LCD (Liquid Crystal Display), LEDs (Light Emitting Diodes), and the like.

The input unit 303 receives an operation instruction from the subject. The input unit 303 may be formed by a keyboard or a touch panel-type display device. The input unit 303 may be formed by a keyboard or a touch panel connected to the subject terminal 300 itself.

The display control unit 304 makes, e.g., instructs, the display unit 302 display the display image received from the posture evaluation apparatus 100C. Specifically, the display control unit 304 makes the display unit 302 display key points and/or a spinal-column edge point group in such a manner that the user or the like can drag them. Further, the display control unit 304 changes the degree of ease of the dragging of a key point according to the probability in the tensor. More specifically, the display control unit 304 changes the degree of ease of the dragging of a key point on the display image based on the below-shown Expression (3).

$$\begin{matrix}[ Expression 3 ] & \\ Δ {x}_{pixel} = \{ \begin{matrix}{v}_{0} & ( p = 0 ) \\ ⌊ {v}_{0} - vp ⌋ & ( p > 0 )\end{matrix} & ( 3 )\end{matrix}$$

In the expression, Δxₚᵢₓₑₗ is the number of pixels the key point moves in one drag operation, and p is a probability in the tensor, i.e., a probability that a pixel included in the photographed image is a joint or an anatomically characteristic point. Further, v₀ is an integer greater than 0, and v is a real number greater than 0. Further,

└v₀−vₚ┘ [Expression 4]
is a largest integer that does not exceed (v₀−vp). That is, in Expression (3), the number Δxₚᵢₓₑₗ of pixels the key point moves in one drag operation is expressed as a function of the probability p in the tensor. Specifically, the number of pixels the key point moves in one drag operation in a part where the probability in the tensor is high is smaller than the number of pixels the key point moves in one drag operation in other parts.

Further, the number Δxₚᵢₓₑₗ of pixels the key point moves in one drag operation is an improper monotone decreasing function of the probability p, and may be a step function in which Δxₚᵢₓₑₗ is an integer greater than 0.

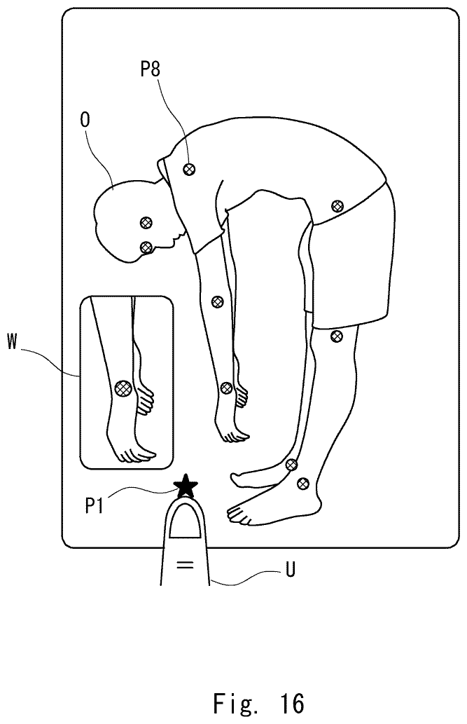

Further, the display control unit 304 makes, e.g., instructs, the display unit 302 display key points in such a manner that the user can drag them, and may display a predetermined range including a pixel having the maximum probability in the tensor in an enlarged manner based on the position of the pixel having the maximum probability and the position of the key point that the user is dragging. For example, as shown in FIG. 16, in the case where, as the display image that is displayed when the user U corrects a key point P1, the tensor is superimposed on the photographed image and a candidate position P8 for the correct position of the key point P1 is displayed, the display control unit 304 makes the display unit 302 display an area around the wrist in an enlarged manner. Specifically, when both of the two conditions described below are satisfied, the display control unit 304 displays an area around the candidate position P8 for the correct position in an enlarged manner.
Condition 1: The distance between the position of the pixel having the maximum probability in the tensor (i.e., the candidate position P8) and the position of the key point that the user is dragging is equal to or shorter than a predetermined distance.
Condition 2: The probability of the candidate position P8 of which the distance from the position of the key point that the user is dragging is equal to or shorter than the aforementioned predetermined distance is equal to or higher than a predetermined threshold.

Further, the display control unit 304 may make the display unit 302 always display a predetermined range centered at the position of the key point that the user is dragging in an enlarged manner.

The communication unit 305 communicates with the posture evaluation apparatus 100C. Further, the communication unit 305 may also communicate with an external server or other terminal apparatuses or the like. The communication unit 305 may include an antenna (not shown) for performing radio communication or an interface such as a NIC (Network Interface Card) for performing wired communication.

According to the fifth example embodiment, the display control unit 304 changes the degree of ease of the dragging of a key point according to the probability in the tensor. Specifically, the number of pixels the key point moves in one drag operation in a part where the probability in the tensor is high is smaller than the number of pixels the key point moves in one drag operation in other parts. In this way, the distance the key point is moved by one dragging operation for the candidate position P8 is reduced, so that the user or the like can move the key point to be corrected to the candidate position P8 more easily.

Further, when the key point that the user U is moving is moved closer to the candidate position P8 during the correction of the key point, the display control unit 304 makes the display unit 302 display an area around the candidate position P8 in an enlarged manner. As a result, the user can easily position the key point to the candidate position P8 during the correction thereof.

Although the present invention is described as a hardware configuration in the above-described example embodiments, the present disclosure is not limited to the hardware configurations. The above-described functions (processes) of the posture evaluation apparatus 100, 100A, 100B or 100C, or the subject terminal 300 may be implemented by, for example, a computer 400 having a configuration described below.

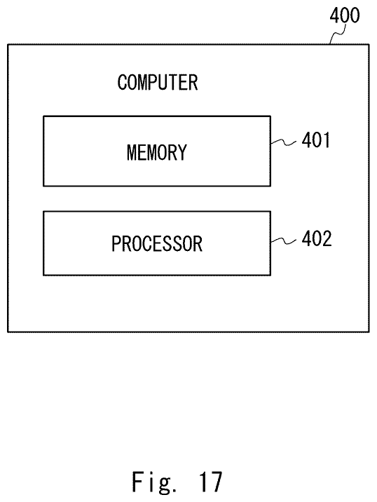

FIG. 17 is a block diagram showing a configuration of a computer 400 for implementing the processes of the posture evaluation apparatus 100, 100A, 100B or 100C, or the subject terminal 300. As shown in FIG. 17, the computer 400 includes a memory 401 and a processor 402.

The memory 401 is composed of, for example, a combination of a volatile memory and a nonvolatile memory. The memory 401 is used to store programs executed by the processor 402 and data used for various processes. Each of the storage unit (not shown) of the posture evaluation apparatus 100, the storage units 110 of the posture evaluation apparatuses 100A, 100B and 100C, and the storage unit (not shown) of the subject terminal 300 may be implemented by the memory 401. However, they may be implemented by other arbitrary storage devices.

The processor 402 processes performed by each apparatus by loading programs from memory 401 and executing the loaded programs. The processor 402 may be, for example, a microprocessor, an MPU (Micro Processor Unit), or a CPU (Central Processing Unit). The processor 402 may include a plurality of processors.

In the above-described examples, the program includes an instruction set (or software code) that, when loaded onto the computer, causes the computer to perform one or more of the functions described in the example embodiments. The program may be stored in a non-transitory computer readable medium or a tangible storage medium. By way of example, and not a limitation, computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

Note that the present disclosure is not limited to the above-described example embodiments, and they may be modified as appropriate without departing from the scope and spirit of the disclosure. For example, the configuration of the posture evaluation apparatus 100, 100A, 100B or 100C may be provided in the subject terminal or the user terminal.

Further, the skeletal-frame extraction model 113 and the additional learning unit 108 may also be provided in the subject terminal. In this case, it is sufficient if only parameters of the skeletal-frame extraction model 113 which has already been trained by additional learning are transmitted from the subject terminal to the posture evaluation apparatus 100A, 100B or 100C by a method such as associative learning. Therefore, it is preferred in view of protecting personal information because the subject terminal does not have to transmit the photographed image of his/her own body to the posture evaluation apparatus 100A, 100B or 100C which is an external server or the like.

Although the present disclosure is described above with reference to example embodiments, the present disclosure is not limited to the above-described example embodiments. Various modifications that can be understood by those skilled in the art can be made to the configuration and details of the present disclosure within the scope and spirit of the disclosure. Further, the example embodiments may be combined with one another as appropriate.

Each of the drawings is merely an example to illustrate one or more embodiments. Each of the drawing is not associated with only one specific embodiment, but may be associated with one or more other embodiments. As will be understood by those skilled in the art, various features or steps described with reference to any one of the drawings may be combined with features or steps shown in one or more other drawings in order to create, for example, an embodiment that is not explicitly shown in the drawings or described in the specification. Not all of the features or steps shown in any one of the drawings to describe an embodiment are necessarily indispensable, and some features or steps may be omitted. The order of steps in any of the drawings may be changed as appropriate.

Further, the whole or part of the example embodiments disclosed above can be described as, but not limited to, the following supplementary notes.

### (Supplementary Note 1)

A posture evaluation apparatus comprising:
a skeletal-frame extraction unit configured to estimate key point position information of key points including joints or anatomically characteristic points of a body of a subject and reliability of the key points from a photographed image obtained by photographing the body;
an image generation unit configured to generate a display image in which a key point having reliability lower than a predetermined threshold is superimposed on the photographed image in a display mode different from that of other key points having reliability equal to or higher than the predetermined threshold;
a skeletal-frame correction unit configured to correct the key point position information based on key point correction information, received from a user, for correcting the key point position information; and a feature value calculation unit configured to calculate feature values related to the joints or the anatomically characteristic points based on the key point position information corrected by the skeletal-frame correction unit.

### (Supplementary Note 2)

The posture evaluation apparatus described in Supplementary note 1, further comprising a state estimation unit configured to estimate a state of a posture of the subject based on the feature values calculated by the feature value calculation unit, wherein the predetermined threshold is determined based on importance of the key point in the estimation by the state estimation unit.

### (Supplementary Note 3)

The posture evaluation apparatus described in Supplementary note 1 or 2, further comprises a spinal-column extraction unit configured to estimate spinal-column edge position information of a spinal-column edge point group including a predetermined number of points representing a shape of a spinal column on the photographed image, wherein
the image generation unit generates the display image by superimposing a key point having reliability lower than the predetermined threshold on the photographed image in a display mode different from that of other key points having reliability equal to or higher than the predetermined threshold, and also superimposing the spinal-column edge point group on the photographed image,
the posture evaluation apparatus further comprises a spinal-column correction unit configured to correct the spinal-column edge position information based on spinal-column edge correction information for correcting the spinal-column edge position information, received from the user, and
the feature value calculation unit calculates the feature values based on the key point position information corrected by the skeletal-frame correction unit and the spinal-column edge position information corrected by the spinal-column correction unit.

### (Supplementary Note 4)

The posture evaluation apparatus described in any one of Supplementary notes 1 to 3, wherein
the skeletal-frame extraction unit estimates the key point position information and the reliability by using a skeletal-frame extraction model that has already been machine-trained, and
the posture evaluation apparatus further comprises an additional learning unit configured to perform additional learning for the skeletal-frame extraction model by using the photographed image and the key point position information corrected by the skeletal-frame correction unit.

### (Supplementary Note 5)

The posture evaluation apparatus described in any one of Supplementary notes 1 to 4, wherein
the skeletal-frame extraction unit also estimates a probability that a pixel included in the photographed image is a joint or an anatomically characteristic point, and
the image generation unit also generates a tensor for displaying the probability by displaying pixels by pixel values corresponding to the probability, and generates the display image by also superimposing the generated tensor on the photographed image.

### (Supplementary Note 6)

The posture evaluation apparatus described in any one of Supplementary notes 1 to 5, further comprising a failure determination unit configured to determine that a process performed in the skeletal-frame extraction unit has failed when the number of key points having reliability lower than the predetermined threshold is equal to or greater than a predetermined criterion.

### (Supplementary Note 7)

A posture evaluation system comprising a posture evaluation apparatus and a subject terminal capable of communicating with the posture evaluation apparatus, wherein
the posture evaluation apparatus includes:
a skeletal-frame extraction unit configured to estimate key point position information of key points including joints or anatomically characteristic points of a body of a subject and reliability of the key points from a photographed image the body of the subject acquired by the subject terminal;
an image generation unit configured to generate a display image in which a key point having reliability lower than a predetermined threshold is superimposed on the photographed image in a display mode different from that of other key points having reliability equal to or higher than the predetermined threshold;
a skeletal-frame correction unit configured to correct the key point position information based on key point correction information, received from a user, for correcting the key point position information; and
a feature value calculation unit configured to calculate feature values related to the joints or the anatomically characteristic points based on the key point position information corrected by the skeletal-frame correction unit.

### (Supplementary Note 8)

The posture evaluation system described in Supplementary note 7 to, wherein
the posture evaluation apparatus further comprises a state estimation unit configured to estimate a state of a posture of the subject based on the feature values calculated by the feature value calculation unit, and
the predetermined threshold is determined based on importance of the key point in the estimation by the state estimation unit.

### (Supplementary Note 9)

The posture evaluation system described in Supplementary note 7 or 8, wherein
the posture evaluation apparatus further comprises a spinal-column extraction unit configured to estimate spinal-column edge position information of a spinal-column edge point group including a predetermined number of points representing a shape of a spinal column on the photographed image,
the image generation unit generates the display image by superimposing a key point having reliability lower than the predetermined threshold on the photographed image in a display mode different from that of other key points having reliability equal to or higher than the predetermined threshold, and also superimposing the spinal-column edge point group on the photographed image,
the posture evaluation apparatus further comprises a spinal-column correction unit configured to correct the spinal-column edge position information based on spinal-column edge correction information for correcting the spinal-column edge position information, received from the user, and
the feature value calculation unit calculates the feature values based on the key point position information corrected by the skeletal-frame correction unit and the spinal-column edge position information corrected by the spinal column correction unit.

### (Supplementary Note 10)

The posture evaluation system described in any one of Supplementary notes 7 to 9, wherein
the skeletal-frame extraction unit estimates the key point position information and the reliability by using a skeletal-frame extraction model that has already been machine-trained, and
the posture evaluation apparatus further comprises an additional learning unit configured to perform additional learning for the skeletal-frame extraction model by using the photographed image and the key point position information corrected by the skeletal-frame correction unit.

### (Supplementary Note 11)

The posture evaluation system described in any one of Supplementary notes 7 to 10, wherein
the skeletal-frame extraction unit also estimates a probability that a pixel included in the photographed image is a joint or an anatomically characteristic point, and
the image generation unit also generates a tensor for displaying the probability by displaying pixels by pixel values corresponding to the probability, and generates the display image by also superimposing the generated tensor on the photographed image.

### (Supplementary Note 12)

The posture evaluation system described in Supplementary note 11, wherein
the subject terminal comprises a display control unit configured to display the display image generated by the image generation unit on the display unit, and
the display control unit makes the display unit display the key points in such a manner that the user can drag the key points, and changes a degree of ease of the dragging of the key point according to the probability in the tensor.

### (Supplementary Note 13)

The posture evaluation system described in Supplementary note 11 or 12, wherein
the subject terminal comprises a display control unit configured to display the display image generated by the image generation unit on the display unit, and
the display control unit makes the display unit display the key points in such a manner that the user can drag the key points, and display a predetermined range including a pixel having a maximum probability in the tensor in an enlarged manner based on the position of the pixel having the maximum probability and a position of the key point that the user is dragging.

### (Supplementary Note 14)

The posture evaluation system described in any one of Supplementary notes 7 to 13, wherein the posture evaluation apparatus further comprises a failure determination unit configured to determine that a process performed in the skeletal-frame extraction unit has failed when the number of key points having reliability lower than the predetermined threshold is equal to or greater than a predetermined criterion.

### (Supplementary Note 15)

A posture evaluation method, wherein a posture evaluation apparatus:
estimates key point position information of key points including joints or anatomically characteristic points of a body of a subject and reliability of the key points from a photographed image obtained by photographing the body;
generates a display image in which a key point having reliability lower than a predetermined threshold is superimposed on the photographed image in a display mode different from that of other key points having reliability equal to or higher than the predetermined threshold;
corrects the key point position information based on key point correction information, received from a user, for correcting the key point position information; and
calculates feature values related to the joints or the anatomically characteristic points based on the key point position information corrected by the skeletal-frame correction unit.

### (Supplementary Note 16)

The posture evaluation method described in Supplementary note 15, wherein the posture evaluation apparatus:
estimates a state of a posture of the subject based on the feature values calculated by the feature value calculation unit;
the predetermined threshold is determined based on importance of the key point in the estimation of the posture.

### (Supplementary Note 17)

The posture evaluation method described in Supplementary note 15 or 16, wherein the posture evaluation apparatus:
estimates spinal-column edge position information of a spinal-column edge point group including a predetermined number of points representing a shape of a spinal column on the photographed image;
generates the display image by superimposing a key point having reliability lower than the predetermined threshold on the photographed image in a display mode different from that of other key points having reliability equal to or higher than the predetermined threshold, and also superimposing the spinal-column edge point group on the photographed image,
corrects the spinal-column edge position information based on spinal-column edge correction information for correcting the spinal-column edge position information, received from the user; and
calculates the feature values based on the corrected key point position information and the corrected spinal-column edge position information.

### (Supplementary Note 18)

The posture evaluation method described in any one of Supplementary notes 15 to 17, wherein the posture evaluation apparatus:
estimates the key point position information and the reliability by using a skeletal-frame extraction model that has already been machine-trained; and
performs additional learning for the skeletal-frame extraction model by using the photographed image and the corrected key point position information.

### (Supplementary Note 19)

The posture evaluation method described in any one of Supplementary notes 15 to 18, wherein the posture evaluation apparatus:
also estimates a probability that a pixel included in the photographed image is a joint or an anatomically characteristic point, and
also generates a tensor for displaying the probability by displaying pixels by pixel values corresponding to the probability, and generates the display image by also superimposing the generated tensor on the photographed image.

### (Supplementary Note 20)

The posture evaluation method described in any one of Supplementary notes 15 to 19, wherein the posture evaluation apparatus determines that an extraction of the key point has failed when the number of key points having reliability lower than the predetermined threshold is equal to or greater than a predetermined criterion.

### (Supplementary Note 21)

A program for causing a posture evaluation apparatus to perform:
a process for estimating key point position information of key points including joints or anatomically characteristic points of a body of a subject and reliability of the key points from a photographed image obtained by photographing the body;
a process for generating a display image in which a key point having reliability lower than a predetermined threshold is superimposed on the photographed image in a display mode different from that of other key points having reliability equal to or higher than the predetermined threshold;
a process for correcting the key point position information based on key point correction information, received from a user, for correcting the key point position information; and
a process for calculating feature values related to the joints or the anatomically characteristic points based on the key point position information corrected by the skeletal-frame correction unit.

### (Supplementary Note 22)

The program described in Supplementary note 21, further causing the posture evaluation apparatus to perform a process for estimating a state of a posture of the subject based on the feature values calculated by the feature value calculation unit, wherein
the predetermined threshold is determined based on importance of the key point in the estimation of the posture.

### (Supplementary Note 23)

The program described in Supplementary note 21 or 22, further causing the posture evaluation apparatus to perform:
a process for estimating spinal-column edge position information of a spinal-column edge point group including a predetermined number of points representing a shape of a spinal column on the photographed image;
a process for generating the display image by superimposing a key point having reliability lower than the predetermined threshold on the photographed image in a display mode different from that of other key points having reliability equal to or higher than the predetermined threshold, and also superimposing the spinal-column edge point group on the photographed image,
a process for correcting the spinal-column edge position information based on spinal-column edge correction information for correcting the spinal-column edge position information, received from the user; and
a process for calculating the feature values based on the corrected key point position information and the corrected spinal-column edge position information.

### (Supplementary Note 24)

The program described in any one of Supplementary notes 21 to 23, further causing the posture evaluation apparatus to perform:
a process for estimating the key point position information and the reliability by using a skeletal-frame extraction model that has already been machine-trained;
a process for performing additional learning for the skeletal-frame extraction model by using the photographed image and the corrected key point position information.

### (Supplementary Note 25)

The program described in any one of Supplementary notes 21 to 24, further causing the posture evaluation apparatus to perform:
a process for also estimating a probability that a pixel included in the photographed image is a joint or an anatomically characteristic point, and
a process for also generating a tensor for displaying the probability by displaying pixels by pixel values corresponding to the probability, and generates the display image by also superimposing the generated tensor on the photographed image.

### (Supplementary Note 26)

The program described in any one of Supplementary notes 21 to 25, further causing the posture evaluation apparatus to perform a process for determining that an extraction of the key point has failed when the number of key points having reliability lower than the predetermined threshold is equal to or greater than a predetermined criterion.

This application is based upon and claims the benefit of priority from Japanese patent application No. 2022-188606, filed on Nov. 25, 2022, the disclosure of which is incorporated herein in its entirety by reference.

### INDUSTRIAL APPLICABILITY

It is possible to provides a posture evaluation apparatus, a posture evaluation system, a posture evaluation method, and a program capable of accurately evaluating a posture.

### REFERENCE SIGNS LIST

100, 100A, 100B, 100C POSTURE EVALUATION APPARATUS
101, 119 SKELETAL-FRAME EXTRACTION UNIT
102 FAILURE DETERMINATION UNIT
103, 115, 120 IMAGE GENERATION UNIT
104, 116 INPUT RECEIVING UNIT
105 SKELETAL-FRAME CORRECTION UNIT
106, 118 FEATURE VALUE CALCULATION UNIT
107 STATE ESTIMATION UNIT
108 ADDITIONAL LEARNING UNIT
114 SPINAL-COLUMN EXTRACTION UNIT
117 SPINAL-COLUMN CORRECTION UNIT
109 INPUT UNIT
110 STORAGE UNIT
111 COMMUNICATION UNIT
112 SKELETAL-FRAME DB (SKELETAL FRAME DATABASE)
113 SKELETAL-FRAME EXTRACTION MODEL
200 POSTURE EVALUATION SYSTEM
300 SUBJECT TERMINAL
301 PHOTOGRAPHING UNIT
302 DISPLAY UNIT
303 INPUT UNIT
304 DISPLAY CONTROL UNIT
305 COMMUNICATION UNIT

1-6. (canceled)

7. A posture evaluation system comprising a posture evaluation apparatus and a subject terminal capable of communicating with the posture evaluation apparatus, wherein
the posture evaluation apparatus includes:
a memory storing instructions; and
one or more processors configured to execute the instructions to:
estimate key point position information of key points including joints or anatomically characteristic points of a body of a subject and reliability of the key points from a photographed image the body of the subject acquired by the subject terminal;
generate a display image in which a key point having reliability lower than a predetermined threshold is superimposed on the photographed image in a display mode different from that of other key points having reliability equal to or higher than the predetermined threshold;
correct the key point position information based on key point correction information, received from a user, for correcting the key point position information; and
calculate feature values related to the joints or the anatomically characteristic points based on the key point position information corrected by the skeletal-frame correction means.

8. The posture evaluation system according to claim 7, wherein
the posture evaluation apparatus the one or more processors configured to execute the instructions to estimate a state of a posture of the subject based on the feature values calculated, and
the predetermined threshold is determined based on importance of the key point in the estimation of the state of the posture.

9. The posture evaluation system according to claim 7, wherein
the posture evaluation apparatus the one or more processors configured to execute the instructions to estimate spinal-column edge position information of a spinal-column edge point group including a predetermined number of points representing a shape of a spinal column on the photographed image,
the one or more processors generates the display image by superimposing a key point having reliability lower than the predetermined threshold on the photographed image in a display mode different from that of other key points having reliability equal to or higher than the predetermined threshold, and also superimposing the spinal-column edge point group on the photographed image,
the one or more processors configured to execute the instructions to correct the spinal-column edge position information based on spinal-column edge correction information for correcting the spinal-column edge position information, received from the user, and
the one or more processors calculates the feature values based on the key point position information corrected and the spinal-column edge position information corrected.

10. The posture evaluation system according to claim 7, wherein
the one or more processors estimates the key point position information and the reliability by using a skeletal-frame extraction model that has already been machine-trained, and
the one or more processors configured to execute the instructions to perform additional learning for the skeletal-frame extraction model by using the photographed image and the key point position information corrected.

11. The posture evaluation system according to claim 7, wherein
the one or more processors also estimates a probability that a pixel included in the photographed image is a joint or an anatomically characteristic point, and
the one or more processors also generates a tensor for displaying the probability by displaying pixels by pixel values corresponding to the probability, and generates the display image by also superimposing the generated tensor on the photographed image.

12. The posture evaluation system according to claim 11, wherein
the subject terminal comprises:
a memory storing instructions; and
one or more processors configured to execute the instructions to:
display the display image generated on the display, and
the one or more processors makes the display display the key points in such a manner that the user can drag the key points, and changes a degree of ease of the dragging of the key point according to the probability in the tensor.

13. The posture evaluation system according to claim 11, wherein
the subject terminal comprises:
a memory storing instructions; and
one or more processors configured to execute the instructions to:
display the display image generated on the display, and
the one or more processors makes the display display the key points in such a manner that the user can drag the key points, and display a predetermined range including a pixel having a maximum probability in the tensor in an enlarged manner based on the position of the pixel having the maximum probability and a position of the key point that the user is dragging.

14. The posture evaluation system according to claim 7, wherein the posture evaluation apparatus the one or more processors configured to execute the instructions to determine that a process in the skeletal-frame extraction means has failed when the number of key points having reliability lower than the predetermined threshold is equal to or greater than a predetermined criterion.

15. A posture evaluation method, wherein a posture evaluation apparatus:
estimates key point position information of key points including joints or anatomically characteristic points of a body of a subject and reliability of the key points from a photographed image obtained by photographing the body;
generates a display image in which a key point having reliability lower than a predetermined threshold is superimposed on the photographed image in a display mode different from that of other key points having reliability equal to or higher than the predetermined threshold;
corrects the key point position information based on key point correction information, received from a user, for correcting the key point position information; and
calculates feature values related to the joints or the anatomically characteristic points based on the key point position information corrected, by the skeletal frame correction means.

16. The posture evaluation method according to claim 15, wherein the posture evaluation apparatus:
estimates a state of a posture of the subject based on the feature values calculated;
the predetermined threshold is determined based on importance of the key point in the estimation of the posture.

17. The posture evaluation method according to claim 15, wherein the posture evaluation apparatus:
estimates spinal-column edge position information of a spinal-column edge point group including a predetermined number of points representing a shape of a spinal column on the photographed image;
generates the display image by superimposing a key point having reliability lower than the predetermined threshold on the photographed image in a display mode different from that of other key points having reliability equal to or higher than the predetermined threshold, and also superimposing the spinal-column edge point group on the photographed image,
corrects the spinal-column edge position information based on spinal-column edge correction information for correcting the spinal-column edge position information, received from the user; and
calculates the feature values based on the corrected key point position information and the corrected spinal-column edge position information.

18. The posture evaluation method according to claim 15, wherein the posture evaluation apparatus:
estimates the key point position information and the reliability by using a skeletal-frame extraction model that has already been machine-trained; and
performs additional learning for the skeletal-frame extraction model by using the photographed image and the corrected key point position information.

19. The posture evaluation method according to claim 15, wherein the posture evaluation apparatus:
also estimates a probability that a pixel included in the photographed image is a joint or an anatomically characteristic point, and
also generates a tensor for displaying the probability by displaying pixels by pixel values corresponding to the probability, and generates the display image by also superimposing the generated tensor on the photographed image.

20. A non-transitory computer readable medium storing a program for causing a computer to perform:
a process for estimating key point position information of key points including joints or anatomically characteristic points of a body of a subject and reliability of the key points from a photographed image obtained by photographing the body;
a process for generating a display image in which a key point having reliability lower than a predetermined threshold is superimposed on the photographed image in a display mode different from that of other key points having reliability equal to or higher than the predetermined threshold;
a process for correcting the key point position information based on key point correction information, received from a user, for correcting the key point position information; and
a process for calculating feature values related to the joints or the anatomically characteristic points based on the key point position information corrected in the process for correcting the key point position information.
